(19) United States
(12) Patent Application Publication
(10) Pub. No.: US 2007/0077459 A1
(43) Pub. Date: Apr. 5, 2007

(54) Compressor-expander with high to idle air flow to fuel cell

(76) Inventors: James F. Walton II, Ballston Lake, NY (US); Paul E. Babson, Clifton Park, NY (US)

Correspondence Address: JAMES C. SIMMONS, 11 FALMOUTH LANE, WILLIAMSVILLE, NY, 14221, US

(21) Appl. No.: 10/438,188

(22) Filed: May 14, 2003

Related U.S. Application Data
(60) Provisional application No. 60/380,533, filed on May 14, 2002.
(60) Provisional application No. 60/396,053, filed on Jul. 15, 2002.

(51) Int. Cl. H01M 8/00; H01M 8/04

(52) U.S. Cl. 429/12; 429/34; 429/26

(57) ABSTRACT

Fuel cell or other combustor apparatus which utilizes a compressor as a source of compressed air. The exhaust is routed to a expander turbine which partially powers the compressor and is on a common shaft therewith. The shaft is borne by hydrodynamic foil bearings. In order to maintain a high compressor speed, compressed air in excess of combustor requirements is bled from the air inlet to the combustor and is preferably passed to the expander turbine.

Priority is hereby claimed of U.S. provisional application Ser. No. 60/380,533, filed May 14, 2002, and of U.S. provisional application Ser. No. 60/396,053, filed Jul. 15, 2002. The disclosures of both of these provisional applications are incorporated herein by reference.

The present invention relates generally to power generation. More particularly, the present invention relates to a compressor-expander system wherein pressurized air (or other suitable pressurized oxygen-containing fluid) is directed to a fuel cell (or other combustor) in which fuel is converted through an electrochemical process to generate electricity (or otherwise burned to provide output power).

In a fuel cell of the PEM (proton exchange membrane) type, hydrogen and oxygen gases are passed over membrane electrodes, creating electricity which is recovered from the electrodes. The oxygen is supplied by a blower or compressor, and the hydrogen (fuel) is supplied from either a pressurized tank or may be extracted from a hydrocarbon fuel through the use of a reformer. Exhaust (at a temperature of typically Apparatus for supplying power to a driven machine comprising a combustor, a compressed air inlet line to said combustor, a compressor for supplying compressed air through said compressed air inlet line to said combustor, a fuel inlet for supplying fuel to said combustor, a combustor outlet for supplying power to the driven machine, an exhaust gas outlet line for exhausting gas from said combustor, a line for bleeding a portion of the compressed air from said compressed air inlet line to decrease the amount of compressed air to said combustor at low power conditions while maintaining a high compressor compressed air output, and a valve in said bleed line for regulating amount of compressed air bleed about 100 degrees C. or higher) in the form of water vapor, carbon dioxide, and the like is formed. While the present invention is shown and described with reference to a PEM fuel cell, it should be understood that it may be used with other types of fuel cells.

A reformer is a device that produces hydrogen from fuels such as gasoline, methanol, ethanol, or naphtha, by combining fuel with steam and heat to generate the needed hydrogen. Types of reformers that are being evaluated for fuel cells for use in vehicles include steam reforming, partial oxidation, and auto-thermal reforming. In general, both methanol and gasoline can be used in any of these three types of reformers.

One application of the present invention would be in plants that produce high value products such as electrical power, clean fuels, and chemicals at low cost. Another example of an application of the present invention is for automotive propulsion wherein a fuel cell must meet an extremely wide and constantly varying operating range from high output power to idle. Such a wide operating range can require air delivery flows from the compressor which are beyond the practical range of a single conventional centrifugal compressor stage, even with expensive and high maintenance variable inlet guide vanes. In such a system, the compressor may operate at very high speeds on the order of 100,000 to 200,000 rpm or more. At very low speeds (on the order of 5,000 to 30,000 rpm) for idle operation, the impeller of the compressor may not be able to ingest enough air to properly run, i.e., it may starve for air and undesirably “surge”.

It is accordingly an object of the present invention to provide a compressor-expander system which can provide variable air (oxygen) flows for high power as well as idle operation to a fuel cell (or other suitable combustor), without employing guide vanes or other expensive, high maintenance complications.

It is a further object of the present invention to provide such a system which is efficient.

It is yet another object of the present invention to provide such a system which allows rapid transition between high power and idle conditions so as to provide good robust performance in applications such as automobiles.

In order to provide such a system, in accordance with the present invention, a fuel cell by-pass is provided wherein excess air is bled from a compressor stage outlet during idle or other low power operations to by-pass the fuel cell. The bleed air is preferably recombined with the fuel cell discharge for passage through the expander so that increased efficiency may be achieved.

The above and other objects, features, and advantages of the present invention will be apparent in the following detailed description of the preferred embodiments thereof when read in conjunction with the accompanying drawings wherein the same reference numerals denote the same or similar parts throughout the several views.

### BRIEF DESCRIPTION OF THE DRAWINGS

FIG. 1 is a schematic view illustrating a compressor-expander system for a fuel cell in accordance with the present invention.

FIG. 2 is an exemplary specific speed graph for the compressor.

FIG. 3 is a front view of a compressor in accordance with an alternative embodiment of the compressor of the present invention.

FIG. 4 is a sectional view thereof taken along lines 4-4 of FIG. 3.

FIG. 5 is a schematic cross sectional view in an axial plane of an alternative embodiment of the present invention.

FIG. 6 is a partially schematic axial cross-sectional view of an alternative embodiment of the present invention which utilizes a combustor.

FIG. 7 is an end view of a valve for controlling the amount of fuel cell by-pass flow and illustrated in a first position.

FIG. 8 is a view similar to that of FIG. 7 of the valve in a second position.

FIG. 9 is a perspective view of a portion of the valve.

FIG. 10 is a partial interface elevational view of portions of the valve.

### DETAILED DESCRIPTION OF THE PREFERRED EMBODIMENTS

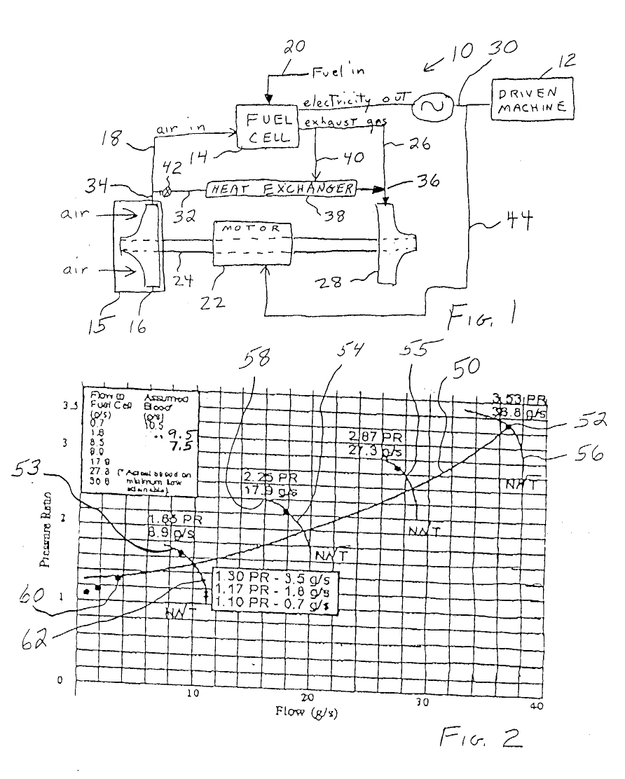

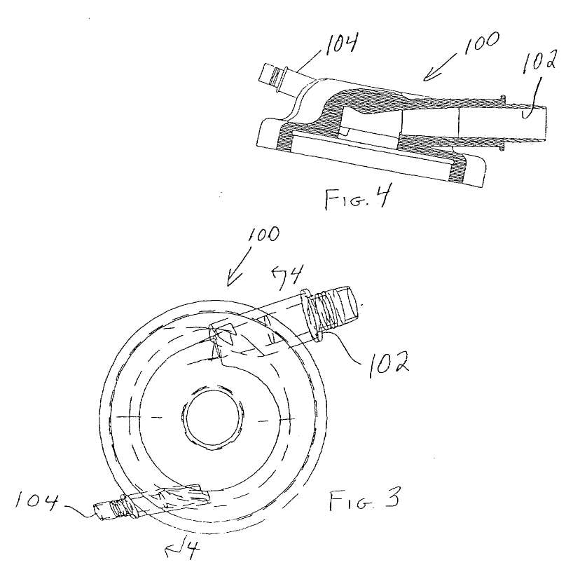

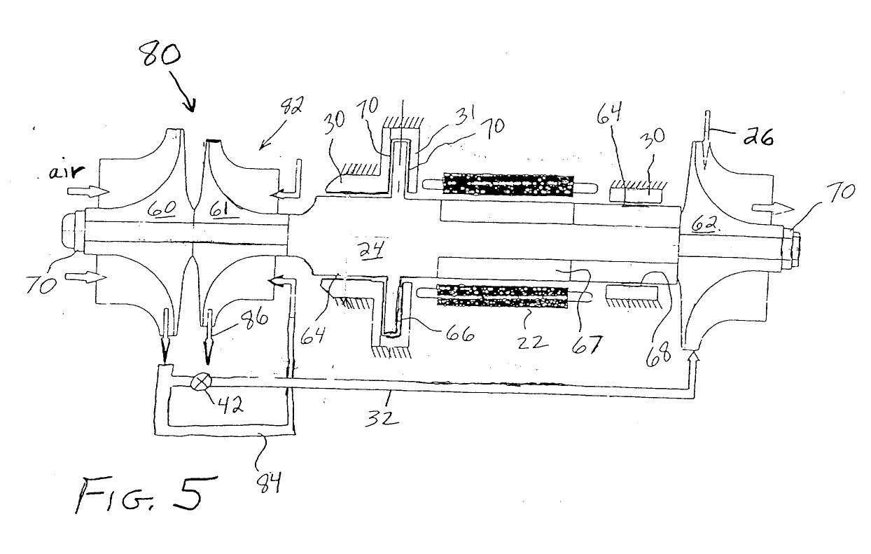

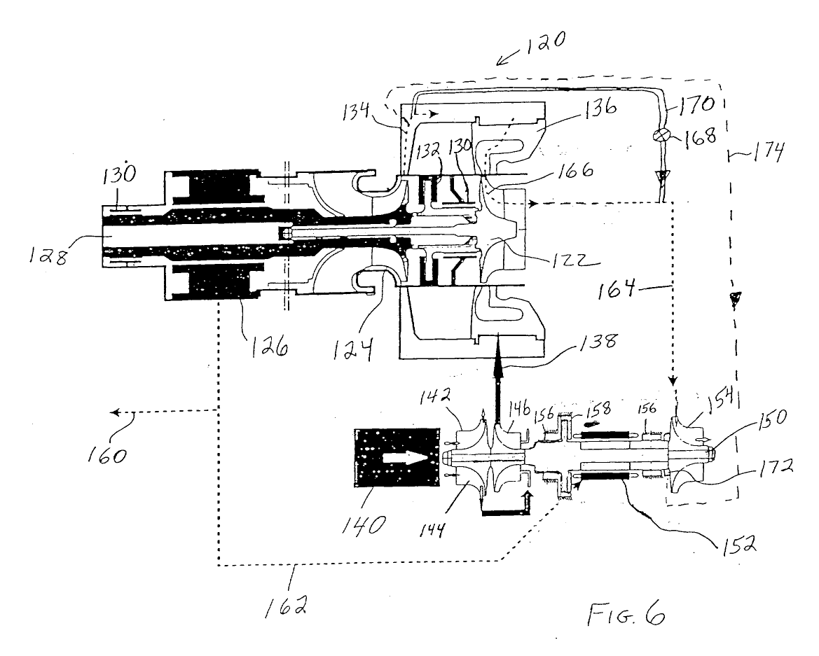

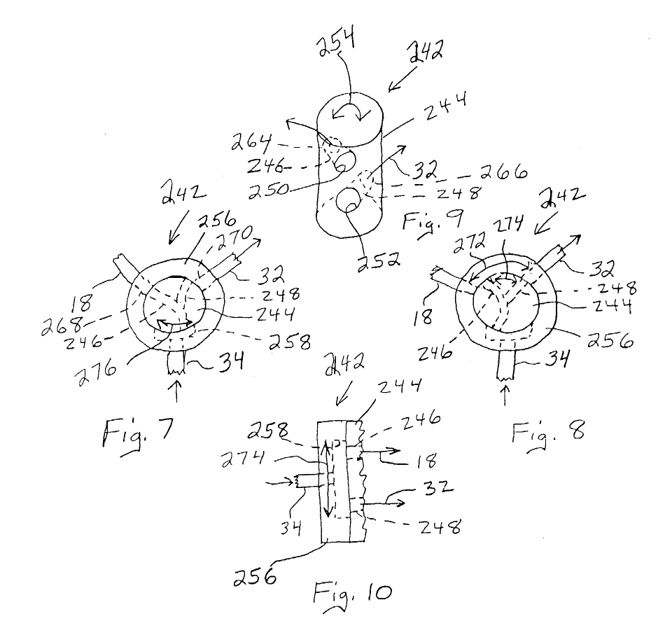

Referring to FIG. 1, there is illustrated generally at 10 a fuel cell arrangement for supplying power for driving a machine 12, which may, for example, be an electric motor for each of the wheels of an automobile. A fuel cell of the PEM type or other suitable combustor 14 receives air (oxygen) from a compressor 15 (having an impeller 16) through line 18 and fuel (hydrogen) through line 20. The electrochemical process resulting when the oxygen and hydrogen are passed between plates of the fuel cell, which is a process commonly known to those of ordinary skill in the art to which this application pertains, or other suitable fuel cell process, produces an electric charge on the membranes of the fuel cell 14 which is outputted as electricity along line 30 to the driven machine 12. Exhaust products are passed through line 26 to an expander turbine 28. As discussed hereinafter, bypass air may be heated by passage thereof through heat exchanger 38 (which may be integral with the fuel cell 14) or by combining with the exhaust gas in line 26.

The compressor impeller 16 is driven by a high speed motor/alternator 22 which is supplied with electricity from line 30 via line 44. The expander 28 is provided to recover energy from the fuel cell exhaust 26 (and otherwise as described hereinafter) so as to supplement energy supplied by the motor 22 for driving the compressor impeller 16, with the result that the motor size may be desirably reduced. The motor/alternator 22 is of variable speed and may, for example, be of the permanent magnet, switch reluctance, or induction type. The expander 28 is shown to be of the radial inflow type, but may alternatively be of the axial inflow type. The expander 28 may be a variable nozzle turbine.

As best seen in FIG. 5 (which is similar to FIG. 1, except that the compressor thereof is a two-stage compressor instead of a single-stage compressor as in FIG. 1), the compressor wheel or wheels or impellers 60 and 61, motor 22, expander wheel 62, radial bearing journals, illustrated at 64 (the radial bearings discussed hereinafter), and thrust bearing runner 66 (the thrust bearing discussed hereinafter) as well as the motor rotor 67 (laminations or permanent magnets or other rotor components) are all mounted on a common shaft 24 to form a rotating group. This assembly is achieved in accordance with principles commonly known to those of ordinary skill in the art to which the present invention pertains. More particularly, the assembly includes the use of radial and axial pilot surfaces, interference fits, and axial compression accomplished by stretching the shaft 24 and then tightening a nut 70 on each of the free ends of the shaft 24 to maintain the axial compression load on the components mounted on the shaft 24.

In order to suitably bear the shaft 24 at the very high speeds involved (on the order of 100,000 to 200,000 rpm or higher) for high power operation, rotation of the shaft 24 is borne by one or more suitable hydrodynamic foil journal bearings, illustrated at 30, and thrust thereof may be borne by one or more suitable hydrodynamic foil thrust bearings, illustrated at 31, the thrust bearing 31 shown to be of the double-acting type wherein the runner 66 bears thrust from either of the axial directions. The bearings 30 and 31 are shown to be located between the compressor and expander wheels. Suitable hydrodynamic foil journal and thrust bearings therefor are shown and described in U.S. Pat. Nos. 6,158,893 and 5,961,217 respectively, which patents are assigned to the assignee of this application and which patents are incorporated herein by reference. Foil bearings are also disclosed in U.S. Pat. Nos. 4,262,975; 4,277,113; 4,300,806; 4,296,976; 4,277,112; 4,277,111; 5,833,369; and 5,902,049 of Hooshang Heshmat (either as sole or as joint inventor), which patents are also incorporated herein by reference. Such foil bearings include a sheet positioned to face a shaft portion for relative movement there between and a member having a corrugated shape with a plurality of ridges or other suitable form for resiliently supporting the sheet thereby defining a compliant hydrodynamic fluid film bearing. The bearing may be a journal bearing for use as bearing 30 in which case the sheet, illustrated at 68, is in surrounding relation to the shaft journal 64 for relative rotational movement there between or a thrust bearing for use as bearing 31 in which case the sheet or sheets, illustrated at 70, bear the runner 66 of the rotating shaft 24. The bearing axis may alternatively be slanted to the radial and axial directions and therefore have the attributes of both a journal and thrust bearing. Stiffness and damping are provided in a foil bearing by the smooth top foil or sheet and structural support elements which are suitably designed to provide a compliant spring support of the desired stiffness (or stiffness which is variable with load) and damping and by the hydrodynamic effects of a gas film between the shaft 24 and the smooth top foil.

At very low speeds (on the order of 5,000 rpm or less) which would otherwise be suitable for low power or idle conditions, the hydrodynamic foil radial/journal and axial/thrust bearings 30 and 31 respectively may not generate sufficient hydrodynamic air pressures to maintain an air film between the shaft journals and thrust runner, or, if an air film is present, may have insufficient pressure to maintain the air film in the presence of transient vibration or shock conditions. Supplementary magnetic bearings may be undesirably complicated and/or bulky for use in such conditions. Consequently, the compressor 15 as well as the other rotating members are desirably constructed to operate at a speed on the order of 30,000 to 50,000 rpm (depending on the size and weight of the operating group) to permit generation of air film pressures sufficient to support the shaft (rotor) 24 as it spins, even in the presence of shock or transient vibrations. Moreover, the impeller 15 of the compressor 16 may not be able to ingest enough air at the low speeds (on the order of 5,000 rpm or less) to properly run, i.e., it may starve for air and undesirably “surge”. Conversely, by operating at the higher speeds (on the order of 30,000 to 50,000 rpm or more), air in excess of fuel cell requirements may be produced, i.e., higher mass flow. In order to achieve desirable and variable air flows to the fuel cell 14 from high power to low power and idle conditions, without employing guide vanes or other expensive, high maintenance complications, in accordance with the present invention, a fuel cell by-pass line, illustrated at 32, is provided wherein a portion of the compressor exhaust air is bled from the compressor outlet, illustrated at 34, during idle or other low power operations, the bleed air passing through by-pass line 32 to by-pass the fuel cell 14. The bleed air is preferably recombined with the fuel cell discharge 26 at point 36 for passage to the expander 28 so that increased efficiency may be achieved. However, if desired, the bleed air may be used to power various auxiliary devices like the conventional bleeding of compressed air from jet airplane compressors for powering various auxiliary devices. Bleed losses should be extremely low, as the bleeds should only be required during the lowest flow modes of the cycle. By directing the bleed air to rejoin, at 36, that which has passed through the fuel cell 14 and directing both through the expander section 28, as seen in FIG. 1, a portion of the bleed flow losses can be partially recovered.

A suitable valve 42 is provided in by-pass line 32 to control bleed air passing through line 32, the valve being preferably automatically controlled, in accordance with principles commonly known to those of ordinary skill in the art to which this invention pertains, to be closed during high power operation and to be open or partially open during low power or idle operation.

In order to match the bleed air pressure to the fuel cell discharge air pressure at the point 36 where recombining takes place, if excess heat can be taken from the fuel cell 14, the bleed air is directed through a heat exchanger 38 that is suitably constructed, using principles commonly known to those of ordinary skill in the art to which this invention pertains, to duplicate the fuel cell pressure drop, and heated gas from the fuel cell 14 routed through line 40 for heat exchange with the bleed air through line 32 for heating thereof to improve the energy recovery efficiency through the expander section 28 as well as to match the bleed air pressure to the fuel cell discharge air pressure at the recombination point 36. Alternatively, such pressure matching may be achieved by throttling bleed air, i.e., by partially closing the valve 42 until the proper bleed air pressure is achieved for matching the fuel cell outlet pressure, in accordance with procedures commonly known to those of ordinary skill in the art to which the present invention pertains.

In order to provide system 10, the impeller 16 for the compressor 15 is selected to satisfy the maximum flow and discharge pressure requirements as required for the driven machine 12. Then, the lowest speed the impeller 16 can be driven to while maintaining flow integrity is determined. At some point above this speed, the maximum discharge flow point at the specific speed that can satisfy the fuel cell inlet pressure requirement is selected as the lowest operating speed. This discharge flow from the compressor section 15 is split to satisfy the fuel cell requirements (less air flow rate) for idle, with the excess air flow by-passed through fuel cell by-pass line 32 to the expander 28, where it rejoins at point 36 the extracted flow as it exhausts from the fuel cell 14, and both bleed air and fuel cell exhaust will then flow through the expander turbine section 28 for maximum energy recovery.

Referring to FIG. 2, there is illustrated at 50 a theoretical graph of the flow rate (in grams per second) requirements through the fuel cell 14 at various pressure ratios (the pressure ratio being defined as the ratio of outlet pressure from the compressor 15 to inlet pressure to the compressor 15). At 52 is the maximum design point for the fuel cell 14 which is shown to be at a pressure ratio of 3.53 and a flow of 38.8 grams per second. At any point along line 50, a specific speed line for the compressor 15 may be drawn. Four such specific speed lines, wherein the compressor speed (defined as the compressor spin speed divided by the square root of the compressor outlet temperature in degrees Kelvin) is constant, are illustrated in FIG. 2 at 53, 54, 55, and 56 respectively. Near the upper ends, as seen in FIG. 2, of the specific speed lines are points, illustrated at 58, where surge conditions would be expected to occur. Before a surge condition is encountered, it is important to increase the compressor speed to a higher specific speed (toward the right along line 50 to a higher specific speed line in FIG. 2, for example, from specific speed line 53 to a higher specific speed line 54) to avoid surge. For example, at point 60, the pressure ratio is 1.30 and the flow requirement for the fuel cell is 3.5 grams per second. With the compressor 15 operating along the specific speed line 53, it is seen that the compressor flow at this specific speed is 11 grams per second, which is well above the 3.5 grams per second fuel cell requirement. The excess flow, or 7.5 grams per second, is, in accordance with the present invention, bled through line 32 to by-pass the fuel cell 14. The other “flows to fuel cell” and “assumed bleeds” (actual based on minimum flow attainable) correlated in FIG. 2 may be similarly found by reference to the graph of FIG. 2. The surge points 58 at the various specific speeds are determined by compressor mapping techniques, and the system may utilize an internal feedback control loop which monitors pressures and flow for automatically increasing and decreasing compressor speed as required, in accordance with principles commonly known to those of ordinary skill in the art to which the present invention pertains. It should be understood that the graph of FIG. 2 and the above examples are exemplary of theoretical conditions only, and each compressor/fuel cell combination will have different operating conditions.

As the flow requirements to the fuel cell 14 increase, the compressor speed is held constant and the bleed by-pass valve 42 caused, automatically or otherwise, to start to close. The resulting increase of flow to the fuel cell 14 will cause its back pressure to increase. This in turn will cause the compressor operating point to climb a specific speed line. This should conserve power, as total compressor discharge flow will decrease, and a higher percentage of the compressor discharge air will now provide increased flow through the fuel cell 14. At some point, i.e., before surge point 58 is reached, the compressor speed must be increased to avoid surge as fuel cell flow requirements continue to increase. The valve 42 will be gradually closed and the bleed by-pass air will gradually diminish to zero at higher compressor speed as the entire flow from the compressor 16 passes through the fuel cell 14. The optimization of the combinations of speed, amount of bleed, and traverses of the specific speed lines as well as the compressor efficiency islands may be achieved for each application to achieve maximum savings commensurate with acceptable performance, using principles commonly known to those of ordinary skill in the art to which this invention pertains.

For automobiles to be commercially viable, it is important that they be able to rapidly accelerate. By adjusting the bleed valve when coming off the idle mode, the bleed line 32 of the present invention advantageously allows an immediately available reserve flow (the bleed flow through line 32) to be immediately directed to the fuel cell 14 so as to ease the typical turbo-charger type lag during rapid acceleration as well as to provide a “dump” when rapid deceleration is initiated. This “reserve flow” and “dump” feature may be employed throughout the operating range to optimize efficiency and performance and thus provide a more robust system for the automotive environment.

Referring to FIGS. 3 and 4, there is illustrated generally at 100 a compressor in accordance with an alternative embodiment of the present invention, the compressor 100 having a main air discharge volute, illustrated at 102. Like the provision of idle jets on a carbureted vehicle, a separate air discharge volute, illustrated at 104, from the compressor 100 is provided for supplying idle mode air flow exclusively and continuously to the fuel cell 14, to thereby advantageously simplify valving. Air from the main volute 102 would then be routed to the fuel cell 14 or to by-pass the fuel cell 14 as determined by fuel cell requirements. Alternatively, a certain percentage, which can be determined using principles commonly known to those of ordinary skill in the art to which this invention pertains, of the compressor volute area may be isolated for direct injection into the fuel cell 14 for the idle mode, with the balance being directed to the by-pass circuit, to also advantageously simplify valving.

The compressor may desirably be a single stage compressor 15, but the present invention is not limited thereto. Thus, if, for example, the maximum compression ratio is greater than is readily accomplished with a single stage, the compressor may be a multi-stage compressor, i.e., two or more centrifugal wheels or stages, one feeding into the other. In a multi-stage compressor, the bleed or by-pass air may be taken from between a pair of the stages (with care taken that the downstream stages are not starved) or after the last stage, using principles commonly known to those of ordinary skill in the art to which the present invention pertains. Referring to FIG. 5, there is shown generally at 80 a compressor-expander system for the fuel cell 14 which has a two-stage compressor 82 having first and second back-to-back impellers 60 and 61 respectively connected for series flow. Thus, air is received by the first impeller 60, compressed to a first pressure, and outputted via line 84 to the inlet to the second impeller 61, where it is compressed to a final pressure, and outputted at 86 to the fuel cell 14. As seen in FIG. 5, the by-pass line 32 receives compressed air from the line 84 at the outlet of the first stage 60. Alternatively, the by-pass line 32 may receive compressed air from the second stage outlet 86. The compressor stages may alternatively be connected for parallel flow wherein each stage receives air from the surroundings and compresses it, and the compressed air from each stage is combined for delivery to the fuel cell 14. The compressor 82 may be otherwise suitably configured, for example, with the compressor wheels or impellers 60 and 61 oriented in the same direction (instead of back-to-back).

Referring to FIG. 6, there is shown generally at 120 a turbine generator assembly wherein a turbine 122, an air compressor 124, and an electrical generator 126 are suitably received on a common shaft 128 and desirably borne by hydrodynamic radial and thrust bearings 130 and 132, similarly as described and shown for FIG. 5. The air compressor 124 supplies compressed air via line 134 to a suitable combustor 136, which receives fuel (in this case, natural gas) via line 138. Natural gas, as illustrated at 140, coming from, for example, a pipeline at a low pressure (on the order of 1 to 2 psig) must be supplied to the combustion chamber 136 of the gas turbine powered generator at pressures as high as 55 psig. The pressure is needed to introduce the gaseous fuel 140 into the combustion chamber at pressures above that of the compressed air 134 being introduced to the combustor 136 from the turbine generator's own air compressor stage(s) 124. The compressed air 134 and compressed gaseous fuel 138 are mixed and burned in the combustion chamber 136. The resulting high temperature gas is then exhausted from the combustor 136 to the stage or stages of the turbine 122, as illustrated at 166. The output power extracted by the turbine stage(s) 122 drives both the air compressor 124 and the generator 126, the generator 126 producing useable electricity, as illustrated at 160.

The natural gas 140 is compressed to the desired pressure by a boost compressor 142 which is shown to have first and second stages 144 and 146 respectively with natural gas compressed in the first stage 144 passing through line 148 to the second stage 146. The boost compressor 142 is suitably mounted on a common shaft 150 with a motor/alternator 152, and an expander 154, and the shaft is borne by hydrodynamic radial and thrust foil bearings 156 and 158, similarly as discussed with reference to FIG. 5. A portion 162 of the electricity generated by the generator 126 is used to drive the gas boost compressor's electric drive motor 152. The exhaust gas 164 from the turbine 122, which exhaust gas still has recoverable energy, is routed to the expander 154 to provide an additional source of energy to drive the gas boost compressor 142 and reduce the energy requirements of the electric motor 152, in order to obtain additional energy savings. If desired, the expander 154 may be eliminated and the turbine exhaust otherwise suitably routed.

In accordance with the present invention, a combustor by-pass or bleed line 170 extends from the turbine generator air compressor outlet line 134 to the turbine exhaust line 164 and has a valve 168 for regulating the amount of bleed passing through line 170, for similar reasons as discussed with respect to FIGS. 1 to 5, using principles commonly known to those of ordinary skill in the art to which the present invention pertains.

In order to segregate the hot turbine exhaust 164 from the compressed natural gas 138, a suitable seal or seals, illustrated at 172, are suitably installed between the booster compressor 142 and the expander 154 (preferably between the motor/alternator 152 and the expander 154. A portion of compressed air 134 is preferably routed through line 174 to the seal or seals 172 to provide such sealing in accordance with principles commonly known to those of ordinary skill in the art to which the present invention pertains.

While valve 42 may for many purposes of the fuel cell 14 be a suitably automatically controlled conventional valve, good robust performance demanded of an automobile requires the ability to achieve rapid transition between high power and idle conditions. Typically, conventional valves will not open and close fast enough to provide such rapid transition. Referring to FIGS. 7 to 10, in order to provide a simple, reliable, economical valving arrangement for controllable by-passing of air through line 32 in a manner which achieves rapid transition between high power and idle conditions, a valve illustrated at 242 is provided at the intersection of the fuel cell and by-pass lines 18 and 32 respectively. Valve 242 includes a solid cylindrical member 244 having first and second passages, illustrated at 246 and 248 respectively, therein for supplying air to the fuel cell and by-pass lines 18 and 32 respectively. Passages 246 and 248 as well as lines 18 and 32 should of course be appropriately sized to each handle all of the flow from the compressor 15. The inlets 250 and 252 (FIG. 9) to passages 246 and 248 respectively are substantially angularly aligned, i.e., at substantially the same location about the circumference of the cylindrical member 244, with the inlet 250 shown to be above inlet 252. The outlets, illustrated at 264 and 266, of the passages 246 and 248 respectively are angularly spaced, i.e., at different locations about the circumference of the cylindrical member 244.

The cylindrical member 244 is rotatably received, as illustrated at 254, in a stationary tubular member 256. Sealing of the member 244 in member 256 is conventionally provided in accordance with principles commonly known to those of ordinary skill in the art to which the present invention pertains. Member 256 has in its inner surface a recess, illustrated at 258. A passage 260 extends between the recess 258 and the outer surface 262 of the stationary member 256, and line 34 from the air compressor 15 connects thereto to provide flow communication from the air compressor 15 to the recess 258 and thence to the passages 246 and 248.

The stationary member 256 has first and second angularly-spaced passages, illustrated at 268 and 270 respectively, extending there through, and lines 18 and 32 are suitably connected to the passages 268 and 270 respectively to provide flow communication between the passages 268 and 270 and the fuel cell and by-pass lines 18 and 32 respectively. As seen in FIGS. 7 and 8, the angular displacement, illustrated at 272, of the stationary member passages 268 and 270 is greater than the angular displacement, illustrated at 274, of the outlets of cylindrical member passages 246 and 248.

FIGS. 7 and 8 illustrate the valve 242, i.e., the rotatable member 244, in two different positions, effected by rotation of the member 244. The rotation of the member 244 is suitably conventionally automatically controlled in response to fuel cell air requirements, and such automatic controls may be provided using principles commonly known to those of ordinary skill in the art to which the present invention pertains. The recess 258 has a height, illustrated at 274 in FIG. 10, to provide flow communication to both of the cylindrical member passages 246 and 248, i.e., the recess 258 extends above the upper passage 246 and below the lower passage 248. The recess 258 has an angular width, illustrated at 276, so that, whether the cylindrical member 244 is in the position shown in FIG. 7 or the position shown in FIG. 8 or any position in between, there remains flow communication between the recess 258 and both of the passages 246 and 248.

As seen in FIG. 7, when there is full flow of air from passage 246 to fuel cell line 18, the by-pass line 32 is closed to the flow of air from passage 248. Similarly, when there is full flow of air from passage 248 to the by-pass line 32, the fuel cell line 18 is closed to the flow of air from passage 246. Between these two extremes, it can be shown that there is a partial flow of air through each of the passages 246 and 248 to the fuel cell and by-pass lines 18 and 32 respectively. The valve 242 is provided to allow the compressor 15 to be operated with desired margins of safety regarding the surge point and with generous by-pass flow to provide response rates faster than can be achieved by speed change of the compressor alone. Such a valve 242 is also provided to desirably achieve rapid response during the deceleration mode. Thus, regulation of the proportion of fuel cell and by-pass air may be achieved by the turning of the cylindrical member 244 through a small angle, whereby rapid transition between high power and idle conditions may desirably be achieved for good robust performance, as required by automobiles and other applications.

The shapes of the outlets from passages 246 and 248 and/or the inlets to 268 and 270 may be varied, in accordance with principles commonly known to those of ordinary skill in the art to which the present invention pertains, to create a vernier effect to gradually vary the rate of change during rotation of the cylindrical member 244.

At the idle condition for a compressor having a single volute, as in FIGS. 1 and 5, the cylindrical member 244 is rotated to a position where the passage 246 is only slightly open to the passage 268 for the fuel cell line 18 to provide only enough air to the fuel cell for idle, the remaining air being by-passed through line 32. However, for a two-volute compressor, such as illustrated in FIGS. 2 and 3, which has a separate volute 104 for idle air, the valve 242 is connected for passage of air from the main air volute 102 to the recess space 258 and the cylindrical member 244 is rotated between a position where all of the air flows through the by-pass 32 for the idle mode and a position where all of the air flows through the fuel cell line 18.

The compressor-expander of the present invention, by providing for the by-passing of unneeded air, combining it with the fuel cell exhaust, and recapturing the energy by expanding it through a turbine, desirably allows the utilization of a low cost compressor while realizing an economical cycle. The rapid response valve 242 is further provided to achieve rapid transition between high power and idle conditions for good robust performance, as required by automobiles and other applications.

It should be understood that, while the present invention has been described in detail herein, the invention can be embodied otherwise without departing from the principles thereof, and such other embodiments are meant to come within the scope of the present invention as defined by the appended claims.

1. (canceled)

2. Apparatus according to claim 3 wherein said power generator is a fuel cell.

3. Apparatus for supplying power to a driven machine comprising a power generator, a compressed air inlet line to said power generator, a single compressor adapted for supplying all compressed air requirements of said power generator through said compressed air inlet line to said power generator, a fuel inlet for supplying fuel to said power generator, a power generator outlet for supplying power to the driven machine, an exhaust gas outlet line for exhausting gas from said power generator, a line for bleeding a portion of the compressed air to decrease the amount of compressed air to said power generator for deceleration of said driven machine, a valve in said bleed line for regulating amount of compressed air bleed, a motor for supplying power for operating said single compressor, and a turbine for receiving exhaust gas from said exhaust gas outlet line for providing additional power for operating said single compressor, wherein said bleed line routes the compressed air bleed to said turbine.

4. Apparatus according to claim 3 further comprising a common shaft on which all of said motor, said compressor and said turbine are mounted, and at least one hydrodynamic foil bearing for bearing said common shaft.

5. (canceled)

6. Apparatus according to claim 3 further comprising a heat exchanger for heating the compressed air bleed.

7. Apparatus according to claim 6 wherein said heat exchanger is adapted to provide a pressure drop through said heat exchanger which is substantially equal to a pressure drop through said power generator.

8. Apparatus according to claim 6 further comprising a line extending from said exhaust gas line to said heat exchanger for supplying heat from the exhaust gas to said heat exchanger.

9. Apparatus according to claim 3 wherein said valve is characterized by being automatically controllable to be closed during acceleration of the driven machine to provide reserve compressed air to said power generator to overcome lag and to be opened to dump excess compressed air from said compressed air inlet line during deceleration of said driven machine.

10. Apparatus according to claim 3 wherein said single compressor includes a first compressed air discharge volute for supplying idle mode compressed air flow continuously to said power generator and a second compressed air discharge volute for supplying power generator compressed air requirements in excess of the idle mode requirements, said bleed line being arranged to bleed compressed air in excess of power generator compressed air requirements from said second discharge volute.

11. Apparatus according to claim 3 wherein said single compressor has a plurality of stages arranged in series, said bleed line arranged for receiving bleed compressed air from between a pair of said stages.

12. Apparatus according to claim 3 wherein said valve comprises a housing having a bore, a cylindrical, member rotatably received in said bore, an inlet to said housing for routing compressed air from said compressor to said cylindrical member, a first outlet from said housing for routing compressed air from said cylindrical member to said power generator, a second outlet from said housing for routing compressed air from said cylindrical member to said bleed line, said cylindrical member including first and second passages having inlets arranged for continuously receiving compressed air from said housing inlet and having outlets the angular displacement of which is different from the angular displacement of said first and second housing outlets whereby rotation of said cylindrical member varies the relative amounts of compressed air delivered to said first and second outlets.

13. (canceled)

14. (canceled)

15. (canceled)

16. (canceled)

17. (canceled)

18. (canceled)

19. (canceled)

20. (canceled)

21. (canceled)

22. Apparatus for supplying power to a driven machine comprising a fuel cell, a compressed air inlet line to said fuel cell, a single compressor operable at a speed in excess of about 30,000 revolutions per minute and adapted for supplying all compressed air requirements of said power generator through said compressed air inlet line to said power generator, at least one hydrodynamic foil bearing for bearing said compressor, a fuel inlet for supplying fuel to said power generator, a power generator outlet for supplying power to the driven machine, a line for bleeding a portion of the compressed air, and means comprising a valve for dumping excess compressed air through said bleeding line for deceleration of the driven machine and for routing increased compressed air flow to said power generator for acceleration of the driven machine while maintaining the speed of said compressor in excess of about 30,000 revolutions per minute during both acceleration and deceleration of the driven machine.

23. Apparatus for supplying power to a driven machine comprising a power generator, a compressed air inlet line to said power generator, a compressor adapted for supplying compressed air through said compressed air inlet line to said power generator, a fuel inlet for supplying fuel to said power generator, a power generator outlet for supplying power to the driven machine, an exhaust gas outlet line for exhausting gas from said power generator, a line for bleeding a portion of the compressed air from said compressed air inlet line to decrease the amount of compressed air to said power generator at low power conditions while maintaining a high compressor compressed air output, a valve in said bleed line for regulating amount of compressed air bleed, a motor for supplying power for operating said compressor, a turbine for receiving exhaust gas from said exhaust gas outlet line for providing additional power for operating said compressor, wherein said bleed line routes the compressed air bleed to said turbine, a common shaft on which all of said motor, said compressor and said turbine are mounted, and at least one hydrodynamic foil bearing for bearing said common shaft.

24. Apparatus according to claim 23 wherein said power generator is a fuel cell.

25. Apparatus according to claim 23 further comprising a heat exchanger for heating the compressed air bleed.

26. Apparatus according to claim 25 wherein said heat exchanger is adapted to provide a pressure drop through said heat exchanger which is substantially equal to a pressure drop through said power generator.

27. Apparatus according to claim 25 further comprising a line extending from said exhaust gas line to said heat exchanger for supplying heat from the exhaust gas to said heat exchanger.

28. Apparatus according to claim 23 wherein said valve is characterized by being automatically controllable to be closed during acceleration of the driven machine to provide reserve compressed air to said power generator to overcome lag and to be opened to dump excess compressed air from said compressed air inlet line during deceleration of said driven machine.

29. Apparatus according to claim 23 wherein said compressor includes a first compressed air discharge volute for supplying idle mode compressed air flow continuously to said power generator and a second compressed air discharge volute for supplying power generator compressed air requirements in excess of the idle mode requirements, said bleed line being arranged to bleed compressed air in excess of power generator compressed air requirements from said second discharge volute.

30. Apparatus according to claim 23 wherein said compressor has a plurality of stages arranged in series, said bleed line arranged for receiving bleed compressed air from between a pair of said stages.

31. Apparatus according to claim 23 wherein said valve comprises a housing having a bore, a cylindrical member rotatably received in said bore, an inlet to said housing for routing compressed air from said compressor to said cylindrical member, a first outlet from said housing for routing compressed air from said cylindrical member to said power generator, a second outlet from said housing for routing compressed air from said cylindrical member to said bleed line, said cylindrical member including first and second passages having inlets arranged for continuously receiving compressed air from said housing inlet and having outlets the angular displacement of which is different from the angular displacement of said first and second housing outlets whereby rotation of said cylindrical member varies the relative amounts of compressed air delivered to said first and second outlets.
